(19) United States
(12) Patent Application Publication
(10) Pub. No.: US 2015/0002354 A1
(43) Pub. Date: Jan. 1, 2015

(54) HORN ANTENNA

(71) Applicant: Thales Holdings UK PLC, Surrey (GB)

(72) Inventor: Brendan Knowles, Sussex (GB)

(21) Appl. No.: 14/371,483

(22) PCT Filed: Jan. 15, 2013
(86) PCT No.: PCT/GB2013/050081

§ 371 Date: Jul. 10, 2014

(30) Foreign Application Priority Data
Jan. 18, 2012 (GB) 1200893.4

(51) Int. Cl. H01Q 13/02

(52) U.S. Cl. CPC H01Q 13/0275
USPC 343/786; 343/908

(57) ABSTRACT

A double ridge horn antenna has open sides between its mouth and a point where a transmission line is coupled to the double ridge structure, in an embodiment, the horn antenna is formed from two parts which when attached together form the double ridge structure.

### FIELD

Embodiments of the present invention relate to microwave radio frequency antennas.

### BACKGROUND

Antennas are used to receive and transmit microwave radio frequency energy. Examples of microwave antennas are the Kerr horn and the Vivaldi antenna. The Kerr Horn is a variant of the four side walled (pyramid) horn. The Kerr horn is a pyramidal horn but with the side walls, parallel to the electric field plane (the E-plane), formed by metal strips spaced apart instead of continuous walls in a conventional horn. [JOHN L. KERR, ‘Short Axial Length Broad-Band Horns’, IEEE Trans. Antennas Propagation., vol. AP-21, pp. 710-715, September 1973.] The Vivaldi antenna has no sidewalls at all, only a central double ridge section, which has traditionally been formed by two PCBs (printed circuit boards) bonded together with a centre track to form the inner transmission line (see http://en.wikipedia.org/wikiNivaldi-antenna).

Conventional microwave horns have large beamwidths at the lowest operating frequency which fall exponentially across the frequency range to the narrow beamwidths at the highest operating frequency. This conventional horn beamwidth reduction is documented for example in ‘Microwave Horns and Feeds’ by A. D Olver. P. J. B. Clarricoats, A. A Kishk and L Shafai Pub IEEE Press 1994, Chap 3 Radiation from Apertures, Section 3.3 Table 3.1 Radiation characteristics of line sources. This table (3.1) details the normal change in 3 dB beamwidth (in radians) of an aperture as a function of wavelength and aperture size, The 3 dB beamwidth (in degrees) change is also shown for a TE01 mode aperture in the E-Plane and magnetic field plane (the H-Plane) in Table 12.1 Chapter 12 Aperture Antennas by C. A. Balanis ‘Antenna Theory’ 2nd Edn Pub John Wiley & Sons 1997.

Both the Kerr and Vivaldi antenna exhibit beamwidths that decrease with frequency. The traditional way of broadening the beamwidth over the upper frequency band is to flare the side horn walls but this tends to lead to main beam bifurcation, as shown in the RF radiation E & H-Plane patterns given in ‘Antenna Engineering Handbook’ by Johnson & Jasik 2nd Edn Pub. McGraw Hill Book Company, Chap 15 Horn Antennas Section 15.2 FIG. 15.3 & FIG. 15.4 (Pages 15-6 & 15-7).

Existing multi octave antenna horn designs have exponential beamwidth drop across the frequency band and require a number of components to construct the horn.

It is an object of the present invention to provide an antenna horn that addresses at least some of the problems discussed above.

### SUMMARY

According to an aspect of the present invention, there is provided a horn antenna. The horn antenna comprises a first plate and a second plate, which are arranged at an acute angle to one another. The first plate and the second plate define a mouth of the antenna at the point where they are furthest apart and a throat of the horn antenna opposing the mouth. The horn antenna has a first ridge extending from the first plate towards the second plate and a second ridge extending from the second plate towards the first plate. The first and second ridges define a slit, which runs from the mouth of the antenna towards the throat. A transmission line is coupled to the slit. The sides of a void defined by the first and second plate are open between the mouth of the antenna and the point where the transmission line is coupled to the slit.

Embodiments of the present invention provide a double ridge horn antenna in which the radiofrequency electric and magnetic fields near the double ridges within the horn are constrained by the walls perpendicular to the electric field plane but not by strips or walls parallel to the electric field plane. Embodiments of the present invention provide a near uniform beamwidth over a multi-octave frequency band.

Embodiments of the present invention are particularly beneficial for Electric Support Measure (ESM) applications where a constant beamwidth across a range of frequencies is advantageous.

In an embodiment, the antenna horn comprises a first part and a second part. The first part and the second part have a common plane, which runs through the first ridge and the second ridge. This allows the horn to be constructed from a small number of parts. The first part and the second part can be accurately machined.

In an embodiment, the transmission line runs along the common plane. This allows the transmission line to be formed from an inner co-axial conductor and a dielectric surrounding it. The first and/or the second part may have a groove in which the insulator and inner co-axial conductor are inserted. The groove may be semicircular.

Embodiments of the present invention allow a horn antenna to be formed from a small number of components.

In an embodiment, the slit is flared towards the mouth of the horn antenna.

In an embodiment, the first plate and the second plate are rectangular. Embodiments of the present invention allow a horn that is miniature in size with respect to is lowest operating frequency to be realised.

Further, embodiments of the present invention provide an antenna horn that is miniature in size when compared with a conventional horn at its lowest operating frequency.

In an embodiment the horn antenna is configured to operate over a frequency range of 3.125 octaves. In an embodiment the first plate and the second plate form an aperture at the mouth of the horn having an aperture width of less than 2 wavelengths at the highest frequency of the frequency range. In an embodiment the aperture width is less than 0.4 wavelengths at the lowest frequency of the frequency range.

Embodiments of the present invention may be realised from a solid conductor, for example aluminium alloy, or alternatively, as an insulator with a conductive coating.

According to a second aspect of the present invention, there is provided a component for forming a double ridge horn antenna with open sides. The component forms one of the first part and the second part described above.

### BRIEF DESCRIPTION OF THE DRAWINGS

In the following, embodiments of the present invention will be described by way of example with reference to the drawings in which:

FIG. 1 shows a perspective view of an antenna horn according to an embodiment of the present invention;

FIG. 2 shows a perspective view of a section of a part of an antenna horn according to an embodiment of the present invention; and

FIG. 3 shows the frequency response of an antenna horn according to an embodiment of the present invention.

### DETAILED DESCRIPTION

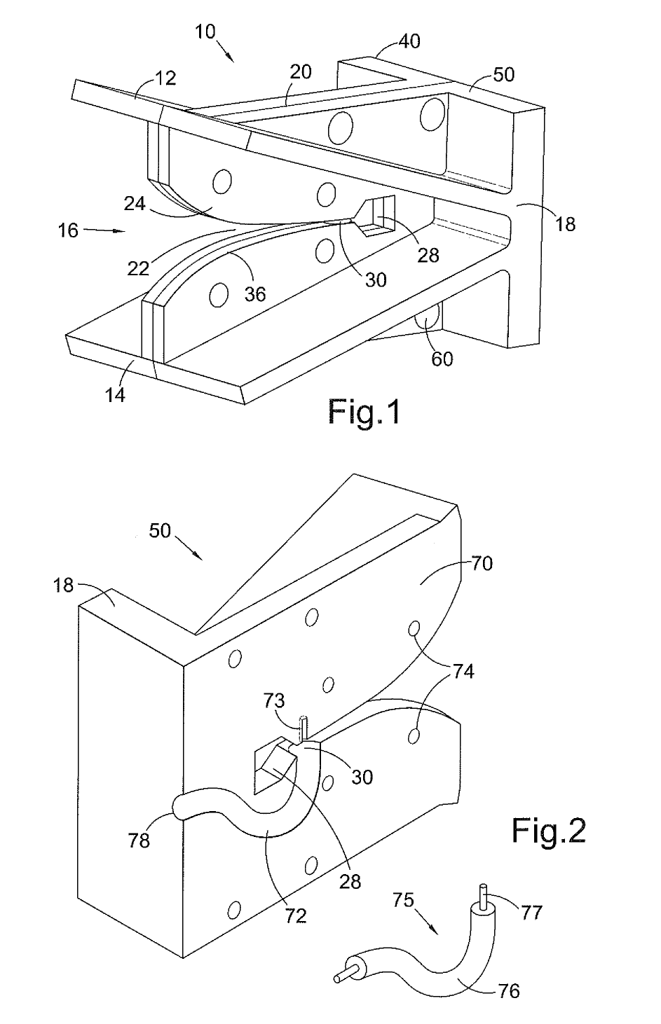

FIG. 1 shows an antenna horn 10. The antenna horn 10 is approximately 30 mm square by 45 mm long. The antenna horn 10 has an upper plate 12 and a lower plate 14 arranged in a “V” shape. The upper plate 12 and the lower plate 14 are rectangular. The opening between the upper plate 12 and the lower plate 14 where they are furthest apart forms the mouth 16 of the horn. The upper plate 12 and the lower plate 14 are attached to a back plate 18. The back plate 18 is square. The upper plate 12 and the lower plate 14 each meet the back plate 18 at a horizontal line on the back plate 18 at an angle of approximately 72 degrees to the plane of the back plate. The upper plate 12 meets the back plate 18 approximately 5 mm above where the lower plate 14 meets the back plate 18. The angle between the upper plate 12 and the lower plate 14 is approximately 32 degrees.

A central plate 20 extends vertically along the central axis of the antenna horn 10 from the back plate 18 to the mouth 16 of the horn 10. The central plate 20 is rectangular and has a slit 22, which runs from the mouth 16 towards the throat of the horn. The slit 22 is flared and is wider at the mouth of the horn than at the throat of the horn. The central plate forms an upper ridge 24 above the slit 22 and a lower ridge 26 below the slit 22. The upper ridge 24 and the lower ridge 26 each form an exponential curve.

The central plate 20 has a rectangular cut-out 28 located in the throat of the horn 10. The slit 22 runs from the mouth 16 to the rectangular cut out 28. A feed point 30 is located in the slit 22, close to the cut-out 28. The feed point 30 is fed by a co-axial transmission line. This is described in more detail with reference to FIG. 2 below.

The body of the antenna horn 10 is formed from two parts: a left side part 40 and a right side part 50. The antenna horn 10 is split through the plane of the central plate 20. The left side part 40 forms half of the upper plate 12, half of the lower plate 14, half of the back plate 18 and half of the central plate 20. The right side part 50 is a mirror image of the left side part 40. The antenna horn 10 is formed by clamping the left side part 40 and the right side part 50 together. The left side part 40 and the right side part 50 are clamped together by screws 60.

The two side parts can be computer numerical control (CMC) machined to ensure precision alignment and accuracy of the double ridge profiles.

FIG. 2 shows a perspective view of the right side part 50 of the antenna horn 10. The right side part 50 has a coupling plane 70, which is placed against the left side part 40 when the antenna horn 10 is assembled. There are 8 holes 74 running into the coupling plane 70 which accommodate the screws shown in FIG. 1 which clamp the right side part 50 to the left side part. A groove 72 runs from the feed point 30 to the centre of the back plate 18. The groove 72 is semi circular in cross-section and follows a path which runs around the rectangular cut out 28. The groove 72 accommodates a transmission line 75. The transmission line runs from the back plane 18 to the feed point 30.

The co-axial transmission line 75 runs from the feed point 30 to an RF port 78. The RF port 78 is located on the rear face of the back plate 18. The co-axial transmission line 75 runs between runs between the left side part 40 and the right side part 50. Each of the left side part 40 and the right side part 50 has a mirror image semi-circular groove to contain the coaxial transmission line 75.

The coaxial transmission line is formed by a low dielectric cylinder 76 with an inner conductor wire 77 running through its centre. The outer conductor of this transmission line is formed by the two left side part 40 and the right side part 50.

The inner conductor wire 77 is longer than the dielectric insulator 76, at both ends.

In the throat of the antenna horn, above the feed point 30 there is a groove 73 in to which one end of the inner conductor wire 77 fits. When the antenna horn is assembled, the inner conductor wire 77 is clamped by the groove 73 and a corresponding recess in the left hand side part 40.

At the other end of the inner conductor wire 77, where it protrudes beyond the back plate 18, the RF port 78 may, for example, be constructed with an SMA flange connector mounted with four small screws, which has a socket type inner conductor, to accept the coaxial transmission line centre conductor. The coaxial transmission line 75 is formed into an open question mark shape “?” prior to being clamped between the left side part 40 and the right side part 50.

The antenna horn is fed from the rear. This provides simple electrical and mechanical assembly of a complete antenna face. In use, the antenna is fixed to a backing plate with all other microwave components behind the backing plate.

In an alternative embodiment, the co-axial cable may extend beyond the backplane. The co-axial cable may be formed as a ‘flying co-axial cable’ and terminated by an RF connector at the end of a cable extending from the antenna. This enhancement reduces the RF loss associated with the mismatch of a standard RF connector, for example a SMA flange connector, when connecting the antenna horn to RF equipment.

The antenna horn described above is formed from aluminium alloy. However those of skill in the art will understand that different metals may be used and further that the antenna may be formed with a conductive skin over non-conductive structure. The antenna horn surfaces are required to have a conductive skin layer or conductive microwave skin depth. The microwave skin depth relates to the microwave current flow depth from the outer surface into the conductive material. Depending on the chosen operating horn frequencies, the microwave skin depth will change; low frequencies require greater skin depth than high frequencies. Therefore, the bulk of the antenna horn can be made of a non conductive material such as plastic which can be metal coated by various means to a thickness or Skin Depth to form an effective microwave conductive horn. The key metal coating factors are ‘Conductivity’, ‘Skin Depth’ and ‘Surface Roughness’. It is envisaged that units may be produced in solid aluminium alloy for convenience and cost if small quantities are required; however plastic plating antenna horns may also be made with a conductive coating where bulk quantities are required.

The antenna horn is a passive microwave device and therefore can be used to transmit and receive microwave RF (Radio Frequency) energy. It has a ‘multi-octave’ frequency range; the antenna horn described above has a 3.125 octave frequency range i.e. within each octave frequency range the lowest to highest frequency is double. For the antenna horn described above the frequency octaves are 2 to 4 GHz, 4 to 8 GHz, 8 to 16 GHz and the fractional octave is 16 to 18 GHz; this forms the ×3.125 octave frequency band. So in total the antenna horn described operates from 2 to 18 GHz.

Those of skill in the art will appreciate that by linearly scaling the antenna horn in three dimensions it can be made to operate over 3.125 octaves at different frequencies. For example, if the antenna horn is scaled smaller in size it could operate over the octaves 3-6 GHz, 6-12 GHz, 12-24 GHz and the fractional octave 24 to 27 GHz, which is from 3 to 27 GHz frequencies. Conversely, if the device is scaled larger it can operate over 3.125 octaves to cover, for example, the frequencies 1 GHz to 9 GHz.

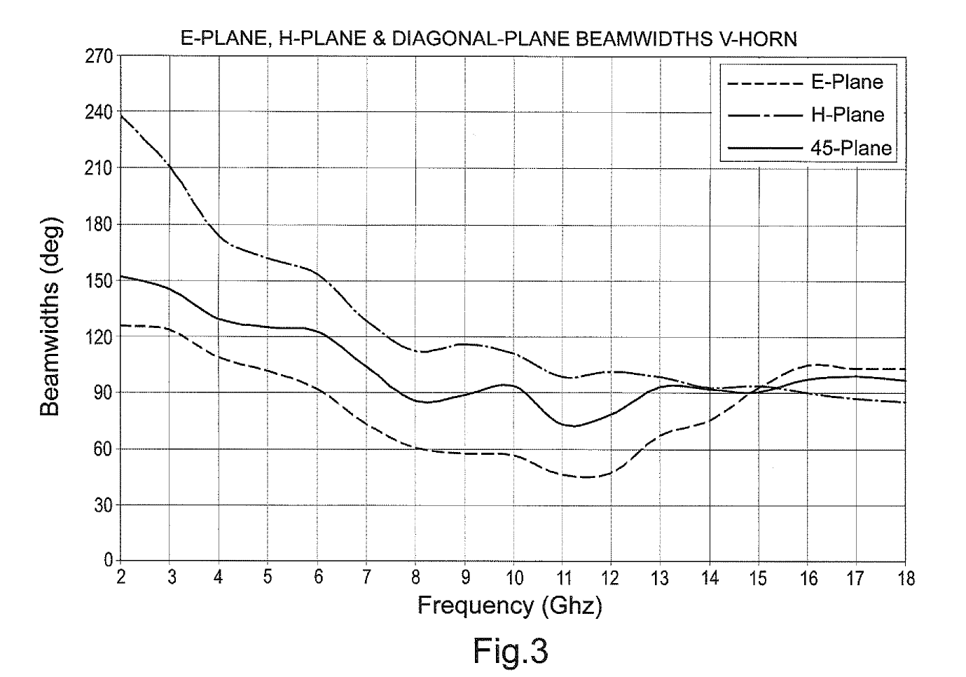

FIG. 3 shows the frequency response of the antenna horn. The antenna horn beamwidths against frequency range form a shallow shape across the band. This is because the radio frequency electric and magnetic fields near the double ridges within the antenna are constrained by the conducting walls perpendicular to the E-plane, but not by walls or strips parallel to the E-plane. The E-plane is the Electric plane and the H-plane is the magnetic plane. The double ridges 26 and 28 are in the E-plane and the upper plate 12 and the lower plate 14 are in the H-plane.

As shown in FIG. 3, the antenna horn design achieves an excellent control of beamwidth with frequency. A beamwidth variation in the E-plane of about 2:1 over 2-18 GHz, with a minimum around 11 GHz and only a small variation over the frequencies 7-18 GHz is achieved.

The dimensions of the antenna horn are 29 mm×29 mm for the aperture face and 42 mm deep. The aperture therefore varies from about 0.2 wavelengths to about 1.75 wavelengths, over the frequency range 2-18 GHz.

Those of skill in the art will appreciate that modifications to the antenna may be made from the configuration described above. For example, the angle between the upper and lower plates may be varied. It has been found that the upper and lower plates affect the horn impedance match due to their proximity to the horn ridge short circuit. The horn ridge short circuit is the cut out 28.

It has also been found that the separation of the upper and lower plates, at the horn aperture, will change the RF horn radiation patterns.

The curve of the double ridges 26 and 28 are chosen by three factors. These are to form an exponential shape, for impedance match reasons, to form a near 50 Ohm ridge impedance, at the horn throat, to match the coaxial transmission line and to have sufficient ridge separation, at the V-Horn aperture, to radiate RF energy at the lowest operating frequency. The smooth exponential curve shown on the double ridges can be formed by a series of flat sections to closely track the exponential form and still maintain an acceptable impedance match. A few flat sections give poor RF match performance but it has been found that ten or more sections will improve the RF match performance.

1. A horn antenna comprising
a first plate and a second plate, the first and second plates being arranged at an acute angle to one another, the first and second plates defining a mouth of the horn antenna at the point where they are furthest apart and a throat of the horn antenna opposing the mouth;
a first ridge extending from the first plate towards the second plate;
a second ridge extending from the second plate towards the first plate, the first and second ridges defining a slit, the slit running from the mouth of the horn antenna towards the throat of the horn antenna;
a transmission line coupled to the slit;
wherein the sides of a void defined by the first and second plates are open between the mouth of the horn antenna and the point where the transmission line is coupled to the slit.

2. The horn antenna according to claim 1, comprising a first part and a second part, the first part and the second part having a common plane, the common plane running through the first ridge and the second ridge.

3. The horn antenna according to claim 2, wherein the transmission line comprises a co-axial transmission line running along the common plane.

4. The horn antenna according to claim 3, wherein the first part and/or the second part has a groove in the common plane and the transmission line comprises a conductor surrounded by an insulator running in the groove.

5. The horn antenna according to claim 4, wherein the first part and the second part each have groove, the grooves being substantially semicircular in cross-section.

6. The horn antenna according to claim 1, wherein the slit is flared towards the mouth of the horn antenna.

7. The horn antenna according to claim 1, wherein the first plate and the second plate are rectangular.

8. The horn antenna according to claim 1, comprising a solid conductor.

9. The horn antenna according to claim 1, comprising an insulator with a conductive coating.

10. The horn antenna according to claim 1 configured to operate over a frequency range of 3.125 octaves.

11. The horn antenna according to claim 10, the first plate and the second plate forming an aperture at the mouth of the horn having an aperture width of less than 2 wavelengths at the highest frequency of the frequency range.

12. The horn antenna according to claim 10, the first plate and the second plate forming an aperture at the mouth of the horn having an aperture width of less than 0.4 wavelengths at the lowest frequency of the frequency range.

13. A component for forming a double ridge horn antenna with open sides, the component comprising a first plate section, a second plate section arranged at an acute angle to the first plate section, a first ridge section extending from the first plate section towards the second plate section and a second ridge section extending from the second plate section towards the first plate section, the first ridge section and the second ridge section defining a coupling plane, wherein the component is configured to be coupled to a second component in the coupling plane.

14. The component according to claim 13 having a groove in the coupling plane, the groove running from a location on the first ridge section.

15. The component according to claim 14 wherein the groove is semicircular.
